(19) United States
(12) Patent Application Publication
(10) Pub. No.: US 2010/0281791 A1
(43) Pub. Date: Nov. 11, 2010

(54) REMOVABLE POST AND METHOD FOR THE ASSEMBLY AND USE THEREOF

(76) Inventors: John D. Intagliata, Antelope, CA (US); Kent A. Kekeis, St. John, IN (US)

Correspondence Address: BRINKS HOFER GILSON & LIONE, P.O. BOX 10395, CHICAGO, IL, 60610, US

(21) Appl. No.: 12/704,993

(22) Filed: Feb. 12, 2010

Related U.S. Application Data
(60) Provisional application No. 61/177,085, filed on May 11, 2009.

(51) Int. Cl. E02D 27/42; E04C 3/00; F16M 13/00; E04F 21/00

(52) U.S. Cl. 52/127.12; 52/849; 52/169.13; 248/519

(57) ABSTRACT

A post assembly includes a post having a bottom and defining a longitudinal axis and a mounting member extending from the bottom of the post along the longitudinal axis. A securing member is moveable between an engaged position, wherein the securing member couples the mounting member to the post in a non-rotatable relationship, and a disengaged position, wherein the mounting member is decoupled and removable from the post. A method of assembling a post assembly is also provided.

### RELATED APPLICATION

The present application claims the benefit of U.S. Provisional Patent Application Ser. No. 61/177,085, filed May 11, 2009, the entire disclosure of which is hereby incorporated by reference.

### FIELD OF THE INVENTION

The present invention relates generally to a removable post, for example for use as a delineator and/or sign post, and to the method of assembling and using such a post.

### BACKGROUND

Posts, such as traffic delineator posts, are frequently mounted on or along roadways to provide delineation and/or instructional information to passersby. Some delineator posts are secured to a base, as shown for example in U.S. Pat. No. 5,518,337 to Modlin and U.S. Pat. No. 4,522,530 to Arthur, which in turn is mounted on top of a surface of the roadway. As such, when not being used to hold a post, the base protrudes from the surface, and is susceptible to damage and abuse from vehicles passing over the base. Moreover, such bases typically require multiple fasteners and/or adhesives to secure them to the ground, or an anchor associated therewith.

In other types of delineator systems, a mounting member, such as a screw or other insert member, extends in a longitudinal direction and is configured to engage a receptacle disposed either below or on top of the roadway surface. Often, the mounting member is integrally or fixedly secured to the post, such that the entire delineator post must be discarded and replaced if the screw or other insert member is damaged. Moreover, such systems may require specialized tools to engage and install the post.

Conversely, some delineator posts are configured with mounting members that may not be secured to the post until such time as the post is attached to a receptacle, as shown for example in U.S. Pat. No. 4,636,108. As such, the mounting member, whether configured as a nut or screw, can be easily lost and may be difficult to position and manipulate, for example in inclement weather. Accordingly, the need remains for a post that can be quickly and easily installed, but which can also be disassembled for targeted component replacement.

### SUMMARY

Briefly stated, a post assembly includes a post having a bottom and defining a longitudinal axis. A mounting member extends from the bottom of the post along the longitudinal axis. A securing member is moveable between an engaged position, wherein the securing member couples the mounting member to the post in a non-rotatable relationship, and a disengaged position, wherein the mounting member is decoupled and removable from the post.

In one embodiment, the post assembly includes a receptacle having an uppermost surface mounted at or below a ground surface. In one embodiment, a base has a bottom surface disposed adjacent the ground surface, with the base defining a socket. A bottom of the post is received in the socket. In one embodiment, a cover is provided to cover at least a portion of the receptacle when not occupied by a post.

In another aspect, a kit includes a post assembly, a receptacle and a cover. The post assembly includes a post having a bottom and defining a longitudinal axis, a mounting member extending from the bottom of the post along the longitudinal axis, and a securing member releasably coupling the mounting member to the post in a non-rotatable relationship. The receptacle has a passageway shaped to receive the mounting member. The receptacle is adapted to be mounted at or below a ground surface. The cover is shaped and configured to cover the passageway when not occupied by the post.

In another aspect, a method for assembling a post assembly includes positioning a mounting member relative to a post such that the mounting member extends from a bottom of the post along a longitudinal axis. The method further includes inserting a securing member transversely to the longitudinal axis through the mounting member and the post such that the mounting member and the post are non-rotatable relative to each other. The method further includes inserting an end portion of the mounting member into a receptacle disposed in the ground.

The various aspects and embodiments provide significant advantages over other post assemblies, including other delineator and/or sign posts. For example and without limitation, the receptacle may be mounted flush with or below the ground surface such that it does not present an obstacle when not occupied by a post. In addition, a cover can be provided to cover the passageway formed in the receptacle, so as to prevent debris from collecting therein.

Moreover, the post assembly can be preassembled and shipped with the mounting member secured to the post, thereby avoiding separate, loose parts and any attendant difficulties in properly positioning and installing the mounting members. Indeed, the receptacle also can be coupled to the mounting member for shipping, such that the entire assembly is shipped as a single, integral unit, with the receptacle then decoupled and installed in the ground on site. Thereafter, the post assembly, and the mounting member in particular, is disposed in the receptacle so as to complete the assembly.

In one embodiment, the mounting member is threadably engaged with the receptacle by turning the post, and/or by using an installation tool, such as a screw driver, to engage and rotate the mounting member relative to the receptacle. In this way, the post assembly is quickly and easily secured to the receptacle with a single mounting member using no tools, or with a readily available conventional tool such as a screw driver.

Moreover, the securing member allows the user to easily and quickly release and decouple the mounting member from the post. In this way, either the mounting member or post can be easily, quickly and inexpensively replaced, for example if damaged during use or over time. Moreover, since the securing member directly engages the mounting member, a more robust connection between the post and the receptacle is realized.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a cross-section view of a first embodiment of a post assembly with an installation tool being applied thereto during installation.

FIG. 2 is a cross-section view of the post assembly shown in FIG. 1 in an installed position.

FIG. 3 is a partially exploded perspective view of the post assembly shown in FIG. 1 with an installation being applied thereto.

FIG. 4 is an exploded perspective view of a second embodiment of a post assembly.

FIG. 5 is a cross-section view of the post assembly shown in FIG. 4.

FIG. 6 is a cross-sectional view of a receptacle mounted in the ground with a cover applied thereto.

FIG. 7 is a partially exploded perspective view of a third embodiment of a post assembly.

FIG. 8 is a partial cross-section view of the post assembly shown in FIG. 7.

FIG. 9 is a partially exploded perspective view of a third embodiment of a post assembly.

FIG. 10 is a partially exploded perspective view of the embodiment shown in FIG. 9.

FIG. 11 is a cross-section view of the post assembly shown in FIG. 10.

FIG. 12 is a partial cross-section view of a fourth embodiment of a post assembly.

FIG. 13 is a cross-section view of a fifth embodiment of a post assembly.

FIG. 14 is a perspective view of the embodiment shown in FIG. 13.

FIG. 15 is a perspective view of an anchor driver tool.

FIG. 16 is a partially exploded perspective view of a post assembly including a sign and a mat.

FIG. 17(a) is cross-section view of a sixth embodiment of a post assembly.

FIG. 17(b) is a top view of an elongated securing member of the embodiment shown in FIG. 17(a).

FIG. 17(c) is an alternative embodiment of the elongated securing member of the embodiment shown in FIG. 17(a).

### DETAILED DESCRIPTION OF THE PRESENTLY PREFERRED EMBODIMENTS

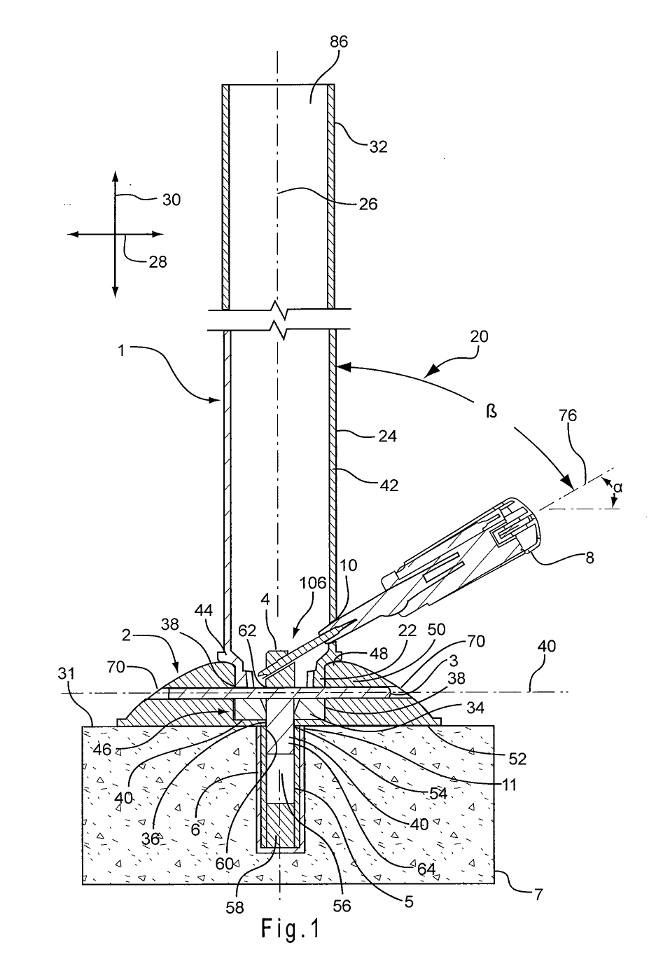

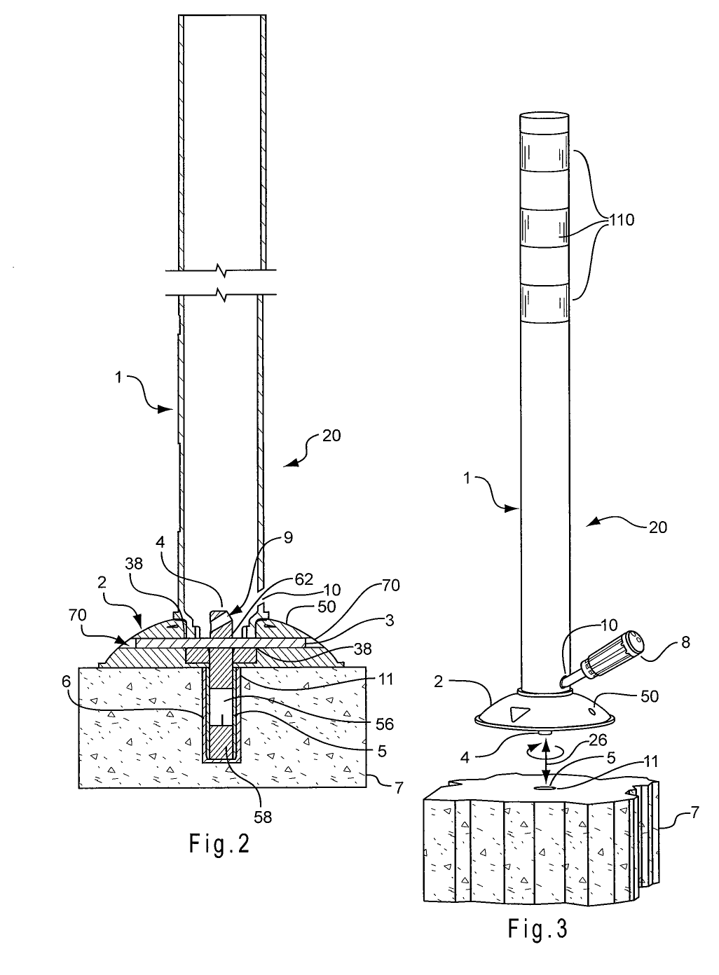

Referring to FIGS. 1-3, a post assembly 20 includes a post 1, formed for example as a tube having a bottom 22 and a top having an opening 86. In one embodiment, the post is formed as disclosed in U.S. Pat. No. 5,518,337, the entire disclosure of which is hereby incorporated herein by reference. For example, the circumferential wall 24 of the tube may be thinner at the top of the tube, whether by continuous tapering or by a cumulative stepping down of the thickness. In one embodiment, the post 1 is flexible, and may be made of various plastic and/or elastomeric materials, including without limitation various polymers including for example and without limitation polyurethane. Of course, it should be understood that the post can also be made of a more rigid material, such as metal, fiberglass, wood, or combinations thereof. The post may be configured with various cross-sectional shapes, including various polygonal, circular, elliptical, oval shapes, and may be solid or tubular.

The post 1 has a length and defines a longitudinal axis 26 therealong. The term “longitudinal” refers to the length or lengthwise direction 30. The term “lateral” refers to a side or side-to-side direction 28, generally substantially perpendicular to the longitudinal direction. The term “transverse” means cross-wise, with the lateral direction 28 running transverse to the longitudinal direction 30.

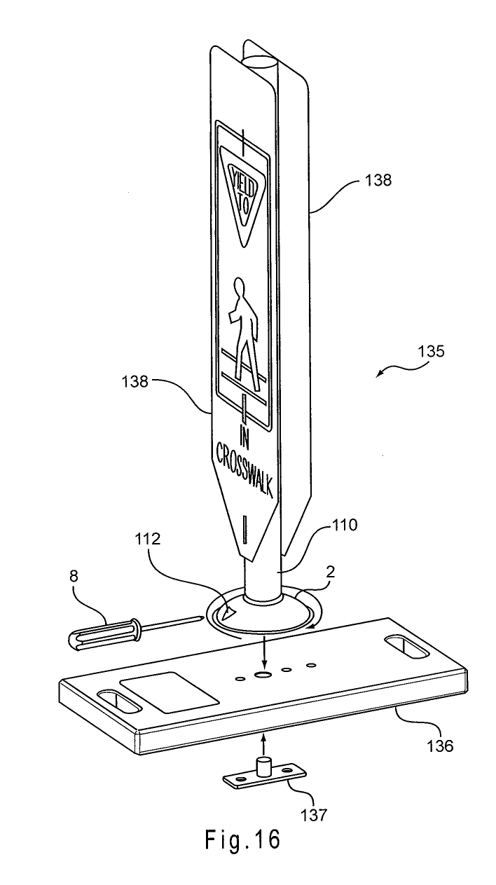

The post 1 may be configured with various instructional indicia 110 applied to an exterior surface thereof as shown in FIG. 3. The instructional indicia may include reflective bands or strips, alphanumeric characters, or may be configured to support a sign coupled thereto, whether integral therewith or separately attached. In one application, the post assembly is configured as a delineator, which is affixed in or on a roadway surface 31 so as to provide directional or boundary information to vehicle operators travelling on the roadway. It should be understood, however, that the post can also be configured to hold or carry various markers or signs, such as a traffic sign (e.g., stop sign) or other information sign having indicia, which can be secured at the top of the post or along the length thereof as disclosed for example and without limitation in FIG. 16 and in U.S. Patent Application Publication No. US2008/0295375, the entire disclosure of which is hereby incorporated herein by reference.

In one embodiment, the bottom 22 of the post is configured as an insert portion, having a lesser cross-sectional area than an upper portion 32 of the post. The insert portion has a bottom wall 34 with a center hole 36 formed therethrough. A pair of aligned openings 38 is formed through opposing portions of a circumferential side wall 39 of the insert portion. The openings 38 define a lateral axis 40 extending transverse to the longitudinal axis 26. An access opening 10 is formed through a circumferential side wall 42 of the upper portion of the post. The exterior junction between the bottom insert portion 22 and the upper portion 32 defines a shoulder 44. The bottom of the post forms and defines an interior cavity 106 in which a mounting member 4 is disposed.

A base 2 defines a socket 46 shaped to receive the bottom 22 of the post, and in particular the insert portion thereof, with the exterior shoulder resting on a mating annular shoulder 48 formed on the base. In one embodiment, the base has a domed upper surface 50, although it should be understood that it could be other suitable shapes, including a frusto-conical shape, pyramid shape, etc. A bottom surface 52 of the base is disposed adjacent to, and in one embodiment, rests on a ground surface 31. The base 2 is preferably impact resistant, and may be made of various polymers, such as polystyrene, or from various metals, rubbers, elastomers, or combinations thereof. The base has a center opening 54 formed in a bottom of the socket 46 and aligned with the opening 36 in the bottom of the post. The base also has a pair of openings 70 formed on opposite sides of the socket 46. The openings 70 are aligned with openings 38 along axis 40 when the bottom 22 of the post is disposed in the socket 46 of the base 2.

It should be understood that the base can be omitted, or that the post and base can be integrally formed as a single post component. In such an embodiment, the bottom of the post is provided with a pair of openings aligned on opposite sides of an interior cavity. Preferably, the bottom surface of the post has sufficient surface area to support the post.

A receptacle 5 is shown as secured in a hole 11 formed in the roadway surface 7, or other substrate, including the ground, such as a pathway, bikepath, driveway, parking garage, etc. In one embodiment, the receptacle 5 is secured in the hole 11 with an epoxy adhesive 6. In one embodiment, the receptacle 5 has a threaded passageway 56 defined along a longitudinal axis 26 thereof. A plug 58 is positioned in the bottom of the receptacle 5. The plug may prevent contaminants, such as adhesive or dirt, from corrupting the internal threads of the receptacle. In one embodiment, a top 60 of the receptacle is positioned at or below the ground surface 31. In this way, the receptacle 5 does not present an obstacle to passing vehicles and is not exposed or susceptible to damage thereby.

The mounting member 4 includes an opening 62 formed therethrough in a lateral direction 28 transverse to the longitudinal axis 26. The mounting member 4 has a threaded end portion 64 configured to threadably engage the threaded passageway 56 of the receptacle. In other suitable embodiments, the mounting member is releasably secured to the receptacle, otherwise referred to as an anchor, with a locking mechanism, including without limitation a spring-loaded locking mechanism such as a coupling with a plurality of detents. The locking mechanism may also include a snap-fit and/or interference fit. In the embodiments shown in FIGS. 1-5, the mounting member 4 is positioned with the end portion 64 extending through the openings 36, 54 formed in the bottom of the post and the bottom of the base socket, with the opening 62 aligned with the openings 38, 70 formed in the bottom portion 22 and the base 2. A transverse opening 9 is formed through an upper end portion of the mounting member 4. In one embodiment, the opening defines an axis 76 forming an acute angle β relative to the longitudinal axis, or an acute angle α relative to the horizontal plane, with the axis 76 having both a lateral and longitudinal component such that an installation tool 8, held at the angle β, can be inserted through the opening 10 in the post and the opening 9 in the mounting member 4. In other embodiments, the opening 9 has a substantially horizontal orientation. In one embodiment, the tool 8 is configured with a rigid rod portion shaped to be inserted through the openings 9, 10, such as a conventional and readily available flathead or phillips head screw driver. In this way, the installer can easily rotate the post assembly without the need for a specialized tool.

A securing member 3, configured in one embodiment as a pin, is removably inserted through the openings 70, 38, 62 in the base, the bottom of the post and the mounting member to an engaged position, such that those components are fixed and non-rotatable relative to each other about the longitudinal axis 26. The securing member 3 also fixes the relative movement of the post 1, base 2 and mounting member 4 in the longitudinal (axial) direction 30. The securing member 3 is preferably made of a metal, such as aluminum or steel, or from other suitable materials such as high-impact plastic. In one preferred embodiment, the securing member 3 has a slight interference fit with the openings 70 in the base, such that the securing member is held in place once it is positioned through the base, post and mounting member in the engaged position. The securing member 3 also may be provided with an interference fit with the openings 38 in the bottom 22 of the post, for example and without limitation where the base is omitted. The securing member may have a horizontal orientation, or may be positioned at an angle relative to the horizontal plane. The engagement of the securing member 3 with the mounting member 4 provides for a robust connection of the post 1 to the substrate 7.

The post assembly 20, including one or more of the post 1, base 2, mounting member 3, securing member 3 and receptacle 5 may be configured as a kit, whether as separate or assembled components. For example, in one embodiment, the post 1, base 2 and mounting member 4 are coupled together with the securing member 3. The receptacle 5 may be maintained separately, or may be threaded on the mounting member 4 for shipping as a single integral unit, whereinafter the receptacle 5 can be removed on-site for installation in the ground.

During assembly, a hole 11 is formed in a substrate, such as the ground. In one embodiment, the receptacle is secured in a roadway surface 7, such as concrete or asphalt, for example with epoxy, preferably with the top 60 of the receptacle 5 at or below the ground surface 31. When secured, the receptacle is non-rotatable about and non-translatable along the axis 26 relative to the substrate. The post assembly, and in particular the mounting member 4, is then screwed into the receptacle 5. Initially, the post assembly 20 can be screwed simply by gripping the post 1 and hand tightening the post assembly. If additional torque is required, or desired, the tool 8 is inserted through the opening 10 in the post and into or through the opening 9 in the mounting member 4. The tool 8 can then be rotated about the longitudinal axis 26 to further engage the receptacle 5 with the mounting member 4 so as to tighten the post 1 against the receptacle 5 and/or ground surface 31. It should be understood that a flat plate 80, such as an enlarged washer (shown for example in FIG. 5) may be disposed under the bottom of the base and/or post.

If the mounting member 4 or post 1 is damaged, for example due to an impact from a passing vehicle or from exposure to the elements, the post assembly 20 can be removed from the receptacle 5 by inserting the installation tool 8 and rotating the post assembly in a direction opposite the installation direction, and/or by grasping the post 1 and rotating the post assembly 20. In either case, the post assembly 20 is decoupled from the receptacle 5. The securing member 3 can then be moved from the engaged position to a disengaged position by pushing the securing member 3 through the openings 70, 38 in at least one side of the post 1 and base 2 and through the opening 62 in the mounting member 4, such that the mounting member 4 is decoupled from the post 1, and can be removed from either end thereof through one of the openings 36, 86. The mounting member 4 may then be reused, if not damaged, with another post, or the post 1 may be reused, if not damaged, with another mounting member. In either case, the separability of the mounting member 4 and post 1 reduces the expense of rehabilitating a damaged post assembly. At the same time, the securing member 3, when in the engaged position, secures the mounting member 4, base 2 and post 1 together without the risk of one or more components being separated and lost, for example during shipping and/or installation. Moreover, only a single mounting member 4 is required, which obviates the need for additional securing fasteners, such as bolts, adhesive, and the like.

It should be understood that the mounting member 4 can be left engaged with the receptacle 5, for example if those components are jammed or corroded together, with the securing member 3 backed out to release the post 1 from the mounting member 4. The mounting member is then exposed for greater manipulation.

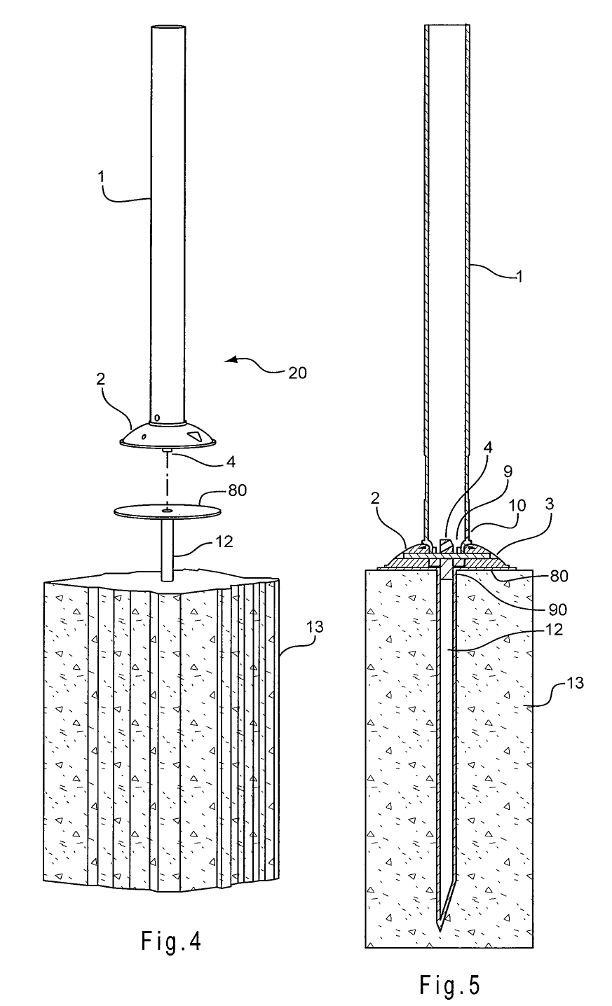

Referring to FIGS. 4 and 5, the post assembly 20 can be used in an application where soil 13 is present rather than asphalt or concrete 7. In this embodiment, an elongated spike 12 is driven into the soil 13. In one embodiment, the top portion of the spike 12 has an internally threaded passageway 90 configured to threadably engage the mounting member 4. An enlarged plate 80 or washer may be secured to, or disposed adjacent to, the top of the spike on the ground surface so as to support the bottom surface of the base 2 and/or post 1. The plate 80 is relatively thin and does not present an obstruction to passing vehicles.

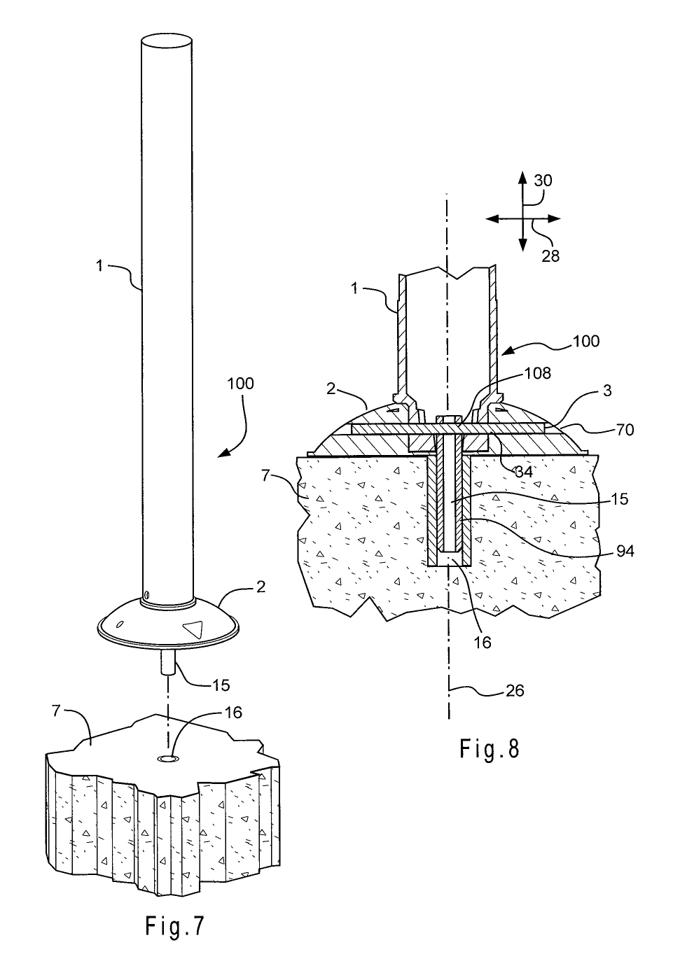

Referring to FIGS. 7 and 8, another embodiment of a post assembly includes a receptacle 16 and a mounting member 15 configured without threads. The receptacle 16 is secured in the substrate with epoxy or by way of a ground spike or other known devices. The mounting member 15 is non-rotatable and removably secured to the post 1 and base 2 with a securing member 3 in the same manner as described above, with the securing member 3 extending through an opening 108 formed through the mounting member 15.

In this embodiment, the mounting member 15 is coupled to the receptacle 16 merely by inserting an end portion 94 of the mounting member into the receptacle, with the end portion and receptacle being slidable relative to each other along the longitudinal axis 26. Preferably, the length of the overlap between the end portion 94 and the receptacle 16 is sufficient to create a wedging and/or friction force therebetween when a lateral force is applied in the lateral direction 28 to the post 1 such that the post 1 is not dislodged from the receptacle 16 during a lateral impact. Instead, the post 1 will flex or bend in response to the lateral impact. At the same time, the post assembly 100, including the post 1, base 2, mounting member 15, and securing member 3, can easily lifted and removed from the receptacle 16 by application of a lifting force in the longitudinal direction 30. In this embodiment, the post does not need to be, but can be, rotated relative to the receptacle. In this way, the post assembly 100 can be easily installed simply by dropping the post, and the mounting member in particular, into the receptacle without rotation or an additional tools. It should be understood that the disposal of the mounting member 15 in the receptacle 16 “couples” those components together. In this embodiment, neither the top of the mounting member nor the post requires an opening shaped and positioned to receive a tool for rotating the post assembly.

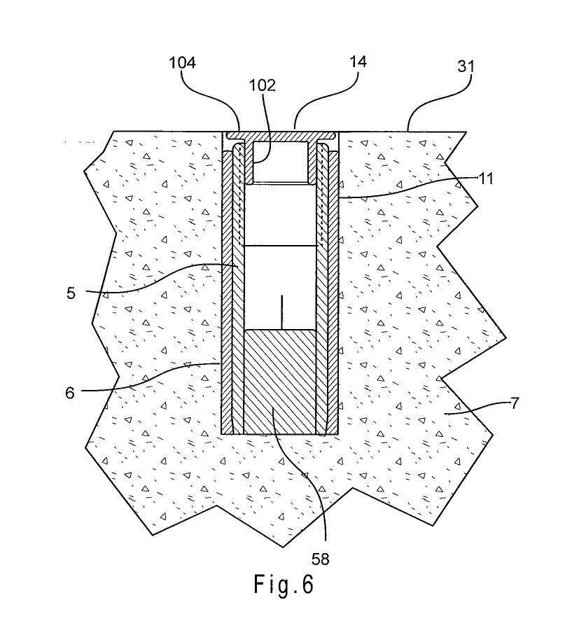

Referring to FIG. 6, a protective cover 14 includes an insert portion 102 disposed in the receptacle and a top cap 104 lying substantially flush with the ground surface 31. The cover 14 can be screwed into the receptacle 5, and may include a tool interface, such as a slot, on a top surface thereof. Alternatively, the cover can be secured to the receptacle with an interference fit and/or snap fit. It should be understood that a protective cover can also be installed in or on the spike 12 of FIGS. 4 and 5 when not occupied by a post assembly. The cover 14 protects the receptacle and prevents debris from collecting therein when a post assembly is not disposed in or secured to the receptacle.

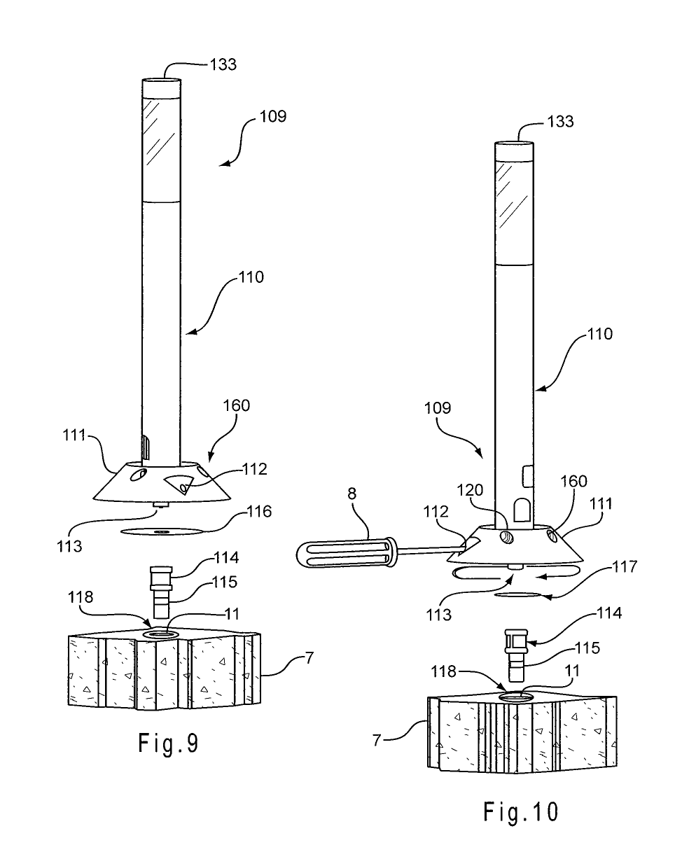

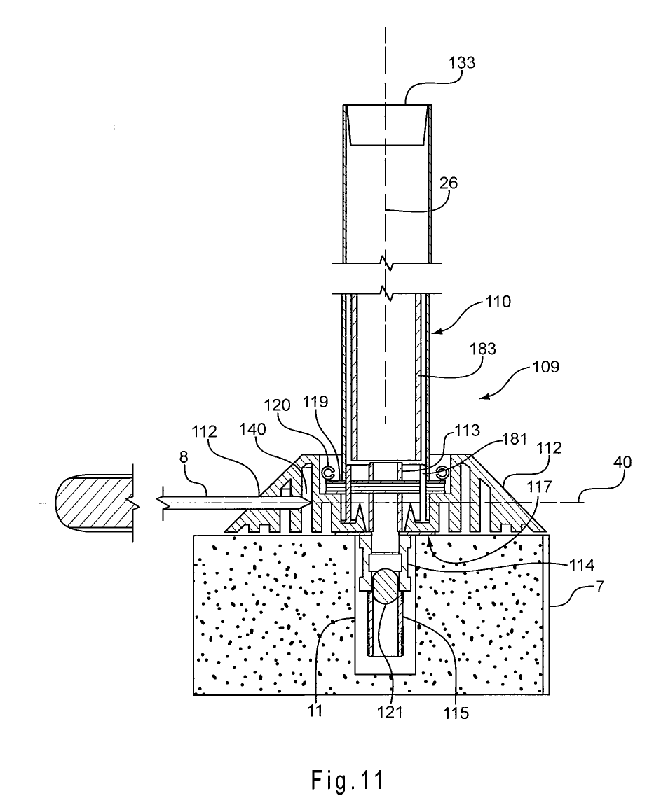

Referring to FIG. 9, another embodiment of a post assembly 109 includes a post 110 having a cap 133 attached to an upper longitudinal end 133 thereof. The post 110 may be attached to a base 111 by combination of corresponding apertures 160 in the post 110 and the base 111 and securing members 119 and 120 or the like, as described above in connection with the embodiment shown in FIG. 1. In one embodiment, shown in FIG. 11, a first securing pin 119 is inserted through the bottom of the post and a reinforcing sleeve 181 disposed therein. The sleeve defines a rim engaging the bottom of the post, and defines feet received in an annular recess formed in the base. An inner tube 183 is disposed in the post above the sleeve 181 and adds strength to the post, for example when impacted by a vehicle. The pin 119 is received in a recess formed in the top of the base, preferably such that the pin 119 is non-rotatable relative the base. After the pin 119 and post are disposed in the base, a pair of securing members 120 is inserted through openings 160 formed in the base and trap the end portions of the securing member 119 against the base and thereby secure the post to the base.

As set forth above, the securing member 120 and the openings 160, as well as the securing member 119 and the openings in the post and sleeve, may have an interference fit, or other suitable attachment feature, such as, for example, mating threads or the like. The bottom of the post 110 forms and defines an interior cavity in which a mounting member 113 having a threaded portion is disposed and secured with the securing member 119. The mounting member 113 may be formed from a standard ½ inch NPT pipe nipple that has been drilled to create the openings for the securing member 119 (See FIG. 11).

The base 111 includes a tool receiving opening 112 that is shaped and sized to receive a tool 8, for example, a commonly available Phillips or flat-head screwdriver, as shown in FIGS. 10 and 11. Turning to FIG. 11, the tool receiving opening 112 may extend from an opening disposed on an outer surface of the base 111 in a laterally/radially inward direction to a terminal end 140. The terminal end 140 may be spaced radially away from the post 110 such that when the tool 8 is inserted therein, the tool 8 does not contact the post 110 or the mounting member 113. As shown in the embodiment of FIG. 11, the tool receiving opening 112 may extend along a lateral axis 40 that is substantially perpendicular to the longitudinal axis 26 of the post 110. However, it should be understood that the orientation of the receiving opening 112 is not limited thereto, and may be oriented in an angled relationship relative to the lateral axis 40 as described above in the embodiment shown in FIG. 1. In this embodiment, the tool engages the base and can be manipulated to rotate the base and mounting member, secured to the base by way of the securing member 119, rather than directly engaging the mounting member as described above with respect to the embodiment of FIG. 1.

Returning to FIG. 9, the post assembly 109 also includes a receptacle 114 having an internally threaded portion for receiving and threadably engaging the threads of the mounting member 113. The receptacle 114 includes an anchor portion 115, which, in one embodiment, has externally facing threads over at least a portion thereof. The receptacle 114 may be made from a standard ½ inch NPT pipe coupling connected to a standard ½ inch by 2 inch NPT pipe nipple, with the pipe nipple forming the anchor 115. The threads on the surface of the anchor portion 115 may provide additional surface area for adhesive bonding, and may provide increased “gripping” or adhesion force for the anchor portion 115 of the receptacle 114 when it is installed in the road 7.

During assembly and installation, the post 110 is initially attached to the base 111, as described above, for example by inserting securing members 120. The mounting member 113 is then inserted through a centrally disposed aperture in a shield 116. The shield 116 may have a circular disk shape and may be formed a polymer having lubricious properties. For example, in one embodiment, the shield may be made from 0.007 inch thick polyethylene terephthalate (PET) film having a slick surface that is not conducive to sticking to adhesives, such as epoxy, which may be used to secure the receptacle 114 to the road 7.

The receptacle 114 is then threaded onto, or otherwise releasably coupled to the mounting member 113 such that the shield 116 is disposed in a sandwich configuration between a bottom surface of the base 111 and the top surface of the receptacle 114. Alternatively, the shield may be disposed around the receptacle. Next, the adhesive (e.g. epoxy or the like) is inserted into the hole 11 and the receptacle 114 is placed into the hole 11. As shown in FIG. 10, a plug 121, formed from, for example, a paper or polymer wadding, may be inserted into the anchor 115 of the receptacle 114 in order to prevent the adhesive from traveling through the receptacle and inadvertently contaminating the internal threads, or bonding the mounting member 113 to the receptacle 114. It should be understood that the receptacle can be mounted in the hole without the post secured thereto.

Returning to FIG. 9, typically, the hole 11 is filled with enough adhesive that when the receptacle 114 including the anchor portion 115 is inserted into the hole 11, the receptacle 114 displaces a portion of the adhesive and may cause it to be expelled out of the hole 11 and onto the surface of the road 7. In this case, an overspill adhesive 118 may form on the surface of the road 7, and can cause unwanted adhesion between the base 111 and the road 7, which may prevent or complicate future removal of the base 111 for repair or replacement. The shield 116 acts as a barrier between the overspill of adhesive 118 on the surface of the road 7 and the base 111. Once the adhesive has fully cured, the post assembly 109 is removed by decoupling the mounting member 113 from the receptacle 114, in this case by unthreading, and the shield 116 is removed. The post assembly 109 is then reattached to the receptacle 114 by threading the mounting member 113 into the receptacle 114.

In addition to preventing inadvertent and unwanted adhesion of the base 111 to the road surface 7, this method of assembly/installation of the post assembly 109 also helps ensure that the longitudinal axes of the receptacle 114 and mounting member 113 are properly aligned. That is, because the receptacle 114 is inserted into the hole 11 and secured to the road 7 with the base 111 and mounting assembly 113 attached thereto, the longitudinal axes of the receptacle 114 and the mounting member 113 are fixed in their preferred, aligned configuration. Further, in this method, the base 111 tends to orient the post assembly 109 in its preferred orientation, which is normal to the surface of the road 7. In contrast, if the receptacle 114 is installed independently of the mounting member 113, the respective longitudinal axes may be offset, thereby causing the post 110 to be angled with respect to the road 7. In extreme cases, the mounting member 113 and the receptacle 114 can be so misaligned that it is not possible for the mounting member 113 to be threaded into, or otherwise coupled to the receptacle 114, thereby preventing installation.

While the foregoing description has been made with regard to the post assembly 109 of FIG. 9, it should be understood that this method of assembling and installing the post assembly 109 may also be used with the post assembly 20 shown in FIG. 1.

Turning to FIGS. 10 and 11, the post assembly 110 is substantially the same as the post assembly 109 of FIG. 9, but includes an anti-rotation member 117. The anti-rotation member 117 may be shaped as a disk and is preferably made from a high-friction material, for example, rubber or neoprene. In one embodiment, the anti-rotation member 117 may be Neoprene disc having a thickness of 1/16 inch. In another embodiment, the anti-rotation member 117 may be rubber disk having a thickness of, for example, ⅛ inch. As shown in FIGS. 10 and 11, the anti-rotation member 117 is disposed between the bottom surface of the base 111 and the surface of the road 7, and in one embodiment above the shield. When the mounting member 113 is threaded into the receptacle 114, the anti-rotation member 117 contacts both the road surface 7 and the bottom surface of the base 111 and increases friction therebetween. This increased friction helps to prevent the base 111 from rotating and spinning out of the receptacle 114 during use. In some embodiments, the anti-rotation member may distort and/or “bunch up” between the base 111 and the road 7 as the mounting member 113 is threaded into the receptacle 114. This bunching and distortion creates additional friction and rotation resistance between the base 111 and the ground 7, and may help prevent the mounting member 113 from spinning loose when a twisting force is applied to the post assembly 110, for example, during an impact with a vehicle or the like. The rotation resistance for a post assembly utilizing an anti-rotation member 117 may be increased by up to 150% as compared to post assemblies without the anti-rotation member 117.

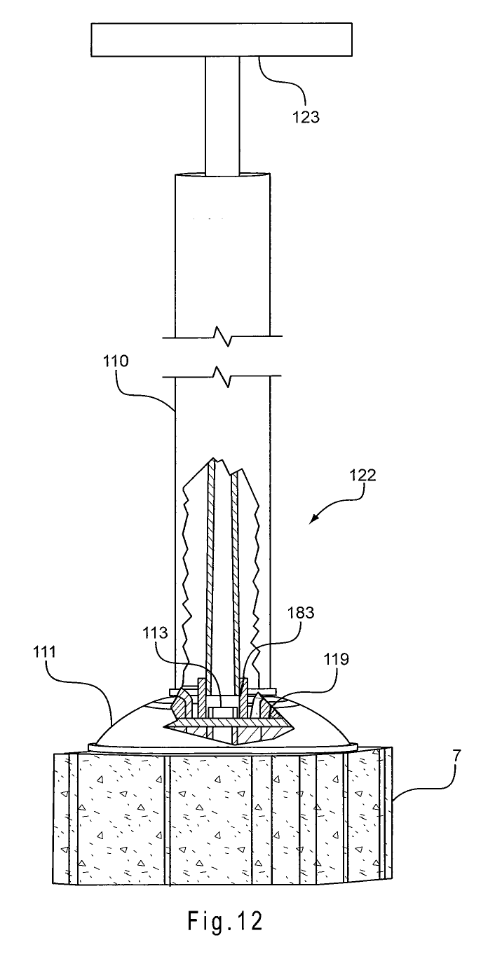

FIG. 12 illustrates another embodiment of a post assembly 122 configured to interface with a tightening tool 123, having a handle, configured in one embodiment as a T-shape. Like the post assemblies 109, 110 the post assembly 122 includes a post 110 attached to a base 111 by a combination of corresponding apertures in the post 110 and the base 111 and at least one securing member 119, 120 or the like. The bottom of the post 110 forms and defines an interior cavity in which a mounting member 113 having a threaded portion is disposed and fixedly attached. The post 110 has an interior passage that extends longitudinally from the top of the post 110 down to or beyond the securing members 119. The tool 123 has a socket end 183 configured to engage the securing member 119. The socket end 183 is inserted from the top end of the post 110, through the post 110 to the securing members 119. For example, the socket end 183 may have one or more cut-outs shaped to receive and engage the securing members 119. Once the lower end of the tool 123 is engaged with the securing members 119, the user can rotate the handle clockwise or counter clockwise to tighten or loosen the mounting member 113 of the post assembly relative to the receptacle 114 as desired. Once the post assembly 122 is tightened or loosened, the tool 123 is then removed from the post 110 and the cap 133 is placed on the top end of the post 110.

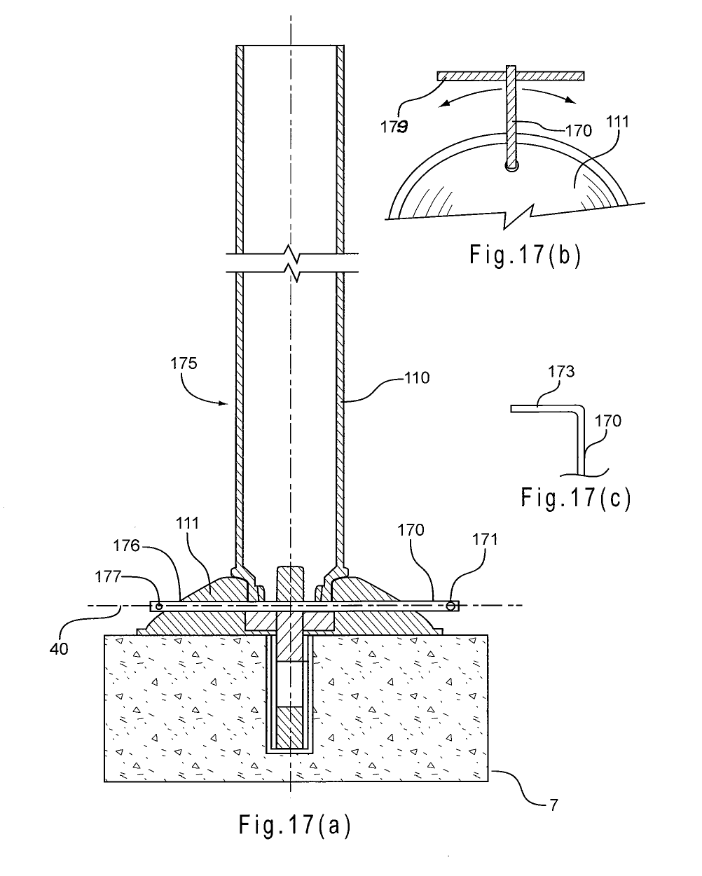

Turning to FIGS. 17(a)-(c), other embodiments of a post assembly 175 are shown. The post assembly 175 includes an elongated securing member 170 that extends outwardly from the base. Like the securing members 119, 120 described above, the elongated securing member 170 may be sized slightly larger than the apertures 176 in the post 1 and the base 2 to create an interference fit therebetween. In one embodiment, the elongated securing member 170 may have a hole 171 that extends transversely through a width thereof. The hole 171 is preferably disposed in an outermost end portion and receives a handle 179 or the like, as shown in FIG. 17(b).

Alternatively, as shown in FIG. 17(c) the elongated securing member 170 may have an L or T-shaped portion at its outer end that can be grasped by a user to rotate the base, and therefore couple or decouple the mounting member 113 relative to the receptacle 114. In these embodiments, the elongated securing member 170 is preferably made from a material having sufficient strength to rotate the base 111 without significant deformation, for example, hardened steel or the like. In this way, the pin functions as both a securing member and a tightening tool. In one embodiment, the diameter of the securing member 170 may be slightly smaller than the opening in the base and post, such that the user can easily insert the pin without a tool, such as a hammer. In this embodiment, an opposite end may extend outwardly from the base such that a locking member 177, e.g., a cotter pin, may be coupled to the securing member to prevent it from slipping out of the base.

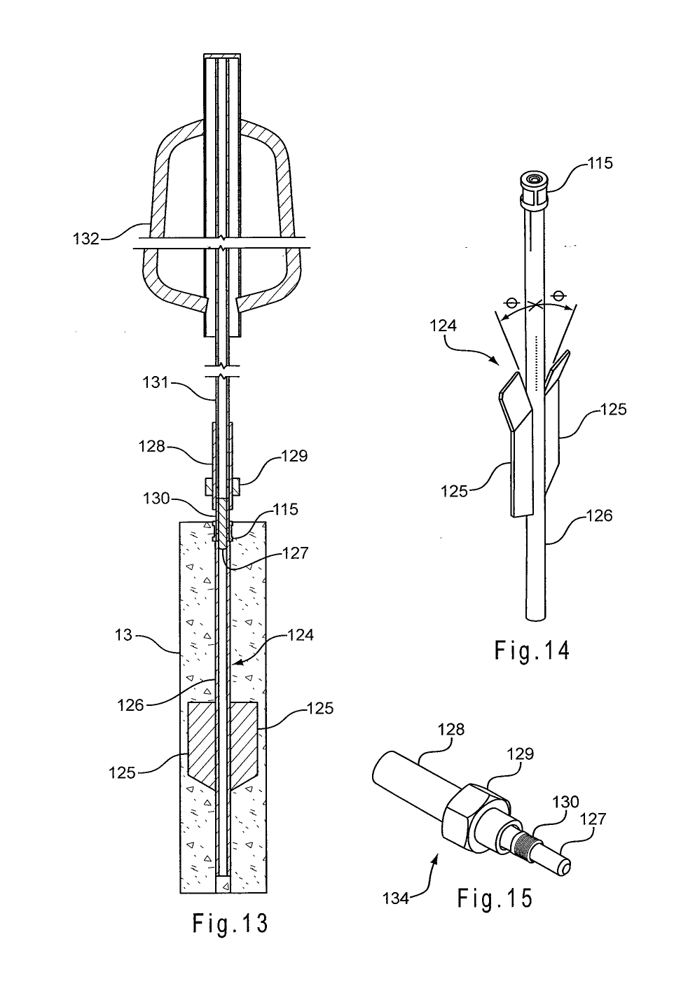

Turning to FIGS. 13 and 14, another embodiment of an anchor 124 for installation of a post assembly in soil/gravel is shown. The soil anchor 124 includes a main body 126 attached to a threaded receptacle 114. The soil anchor 124 may be made from standard, commercially available pipe and pipe fittings, as described above in connection with the embodiments of FIGS. 9-11. The soil anchor 124 includes at least one, and preferably two fins or wings 125. The wings 125 are attached to, and extend outward from, the main body 126, and preferably have a sufficiently large surface area to provide adequate contact area with the surrounding soil or gravel when installed to counteract a twisting force applied during tightening and loosening of the post assembly. In one embodiment, an upper portion of one or both of the wings 125 is bent at an angle θ to help hold the soil anchor 124 in the soil/gravel when an upward force is applied thereto, such as when the attached post assembly is impacted by a moving vehicle. Note that any post assembly disclosed within this application, may be attached to the soil anchor 124.

The soil anchor 124 may be installed in the ground using standard tools, for example, a fence post driver 132, and a driver pipe 131. The driver pipe 131 may be formed from a piece of standard pipe, for example, a ½ inch NPT pipe having a 48 inch length and a threaded end portion which can be threaded into the threaded receptacle 114 for installation. Alternatively, a specialized driver tool 134, as shown in FIG. 15, may be utilized. The driver tool 134 includes a plug 127 disposed on a threaded end 130 that prevents dirt or gravel from entering into the threads of the soil anchor 124 as the top of the soil anchor 124 is driven into the ground to a position approximating the soil surface. A nut 129 is provided on a body of the driver tool 134 to allow the driver tool to be securely tightened to the receptacle 114. The driver tool 134 also includes a section of pipe 128 that is sized slightly larger than the driver pipe 131 so as to receive the driver pipe 131 and ensure that the driver pipe 131 maintains a centered position on the threaded stem 130 during installation.

Referring to FIG. 16, a post assembly 135 having attached signage 138 is shown. The signage 138 may include sign panels indicating a crosswalk, an intersection, work zones, or the like. The post assembly 135 is mounted to a mat 136 having a size and weight that is readily portable by a person, used for example in applications such as work zones where the delineators are moved frequently. For example, in one embodiment, the mat 136 is 14 inches wide by 30 inches long by 2 and ⅛ inches high, and weighs about 32 lbs. The mat 136 may be made from crumb rubber or any suitable material known in the art. The mat may include a recess sized to receive a threaded receptacle 137. As described above in connection with other embodiments, the post assembly 135 also includes a mounting member 113 having threads or the like to couple the mounting member 113 to the receptacle 137 by threaded engagement or the like.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A post assembly comprising:
a post having a bottom and defining a longitudinal axis;
a mounting member extending from said bottom of said post along said longitudinal axis; and
a securing member moveable between an engaged position, wherein said securing member couples said mounting member to said post in a non-rotatable relationship, and a disengaged position, wherein said mounting member is decoupled and removable from said post.

2. The post assembly of claim 1 further comprising a receptacle, wherein said mounting member has an end portion removably received in said receptacle, wherein said post is coupled to said receptacle.

3. The post assembly of claim 2 wherein said receptacle and said end portion of said mounting member comprise mating threaded portions.

4. The post assembly of claim 2 wherein said receptacle and said end portion of said mounting member are slidable relative to each other along said longitudinal axis.

5. The post assembly of claim 1 wherein said securing member comprises a pin removably inserted through said mounting member transversely to said longitudinal axis.

6. The post assembly of claim 5 wherein said pin is moveable along a substantially horizontal axis between said engaged and disengaged positions.

7. The post assembly of claim 1 further comprising a base, wherein said securing member further couples said post to said base when in said engaged position, and decouples said post from said base when in said disengaged position.

8. The post assembly of claim 1 wherein said mounting member has an opening formed therein, said opening shaped to receive a tool.

9. The post assembly of claim 8 wherein said opening defines an axis formed at an acute angle relative to said longitudinal axis.

10. A post assembly comprising:
a receptacle having an uppermost surface mounted at or below a ground surface;
a base having a bottom surface disposed adjacent said ground surface, said base defining a socket;
a post having a bottom received in said socket;
a mounting member extending from said bottom of said post along a substantially vertical axis, wherein said mounting member comprises an end portion removably received in said receptacle; and
a securing member moveable between an engaged position, wherein said securing member extends through said mounting member, said post and at least a portion of said base such that said mounting member, said post and said base are non-rotatable relative to each other, and a disengaged position, wherein said securing member is free from engagement with said mounting member, wherein at least said post is moveable relative to said mounting member along said vertical axis.

11. The post assembly of claim 10 wherein said receptacle and said end portion of said mounting member comprise mating threaded portions.

12. The post assembly of claim 10 wherein said receptacle and said end portion of said mounting member are vertically slidable relative to each other along said vertical axis.

13. The post assembly of claim 10 wherein said securing member comprises a pin removably inserted through said mounting member transversely to said vertical axis.

14. The post assembly of claim 13 wherein said pin is moveable along a horizontal axis between said engaged and disengaged positions.

15. The post assembly of claim 10 wherein said mounting member has an opening formed therein, said opening shaped to receive a tool.

16. The post assembly of claim 15 wherein said opening defines an axis formed at an acute angle relative to a horizontal plane.

17-28. (canceled)

29. The post assembly of claim 7, further comprising an anti-rotation member disposed adjacent a bottom surface of said base, said anti-rotation member frictionally engaging said bottom surface of said base.

30. The post assembly of claim 10, further comprising an anti-rotation member disposed between a bottom surface of said base and said surface of the ground, said anti-rotation member frictionally engaging said bottom surface of said base and said surface of said ground when said mounting member is coupled to said receptacle.

31. The post assembly of claim 7, wherein said base member includes an opening extending from a surface of the base toward a center thereof, said opening sized and shaped to receive a tool.

32. The post assembly of claim 10, wherein said base member includes an opening extending from a surface of the base toward a center thereof, said opening sized and shaped to receive a tool.

33. The post assembly of claim 10, wherein said securing member in said engaged position has at least one end that extends outward beyond the base to define a handle for grasping and securing the mounting member to the receptacle.

34-39. (canceled)

40. A post assembly comprising:
a post having a bottom and defining a longitudinal axis;
a base including a mounting member extending from said bottom of base along said longitudinal axis; and
a securing member moveable between an engaged position, wherein said securing member couples said base to said post in a non-rotatable relationship, and a disengaged position, wherein said base is decoupled and removable from said post.

41. The post assembly of claim 40 further comprising a receptacle, wherein said mounting member has an end portion removably received in said receptacle, wherein said post is coupled to said receptacle.

42. The post assembly of claim 40 wherein said securing member extends transversely to said longitudinal axis.

43. The post assembly of claim 40 wherein said securing member engages said mounting member.
